(19) United States
(12) Patent Application Publication
(10) Pub. No.: US 2015/0289461 A1
(43) Pub. Date: Oct. 15, 2015

(54) SELF-WATERING FLOWERPOT

(71) Applicant: ZHUHAI MAXUNI MOULD CO., LTD, Zhuhai City (CN)

(72) Inventors: Leo LIU, Zhuhai City (CN); Monkdy MENG, Zhuhai City (CN)

(21) Appl. No.: 14/547,526

(22) Filed: Nov. 19, 2014

(30) Foreign Application Priority Data
Apr. 10, 2014 (CN) 201420193199.X

(51) Int. Cl. A01G 27/00; A01G 25/16

(52) U.S. Cl. CPC A01G 27/006; A01G 25/16

(57) ABSTRACT

The present invention discloses a self-watering flower pot, comprising an outer pot, an inner pot and a water absorption rod connecting the outer pot with the inner pot. One end of the water absorption rod is inserted into the bottom of the said outer pot, and the other end protrudes into the soil of the inner pot. A support pillar integrated with the bottom surface of the inner pot makes the inner pot flush with the outer pot, with a well of water between the two. A water level indicator is placed in the flower pot so that users can check water level any time. The water absorption rod continuously waters the plant automatically. Convenient and time-saving, the device solves the problem of often watering.

### TECHNICAL FIELD

The present invention generally relates to the field of flowerpot containers, particularly, a self-watering flowerpot.

### BACKGROUND OF THE INVENTION

In today's society, planting different sorts of plants in flowerpots to purify air and environment is popular in families and workplaces. However, the flowerpots on the market, most of which are suitable only for plants and soils cannot facilitate automatic watering, and plants growing in these flowerpots need to be frequently watered (once every three to seven days). If users are busy with work or on business trips, the plants not sufficiently watered will wither due to lack of water and nutrients.

### SUMMARY OF THE INVENTION

This invention provides an easy-to-use self-watering flowerpot, which can continuously supply water to the soil for the purpose of automatic watering.

In order to solve the said technical problem, the technical scheme of this invention is that the self-watering flowerpot is characterized by comprising the outer pot, the inner pot and the water absorbing rod connecting the outer pot and the inner pot, one end of the said water absorption rod is inserted into the bottom of the outer pot, and the other end protrudes into the soil of the said inner pot; a support pillar integrated with the inner pot is placed on the bottom surface of the inner pot and supports the inner pot which is flush with the outer pot, and a water tank is shaped between the said inner pot and the said outer pot.

Further, the said water absorbing rod is made of nylon plastic; the middle portion of the water absorbing rod is hollowed; the water absorbing rod at its peripheral part is provided with small water absorbing holes that are connected with the said middle hollowed portion; a lot of water absorbing holes running through the water absorbing rod are arranged around the part that are symmetric relative to the middle hollowed portion of the said water absorbing rod; a water level indicator is installed in a cavity enclosed by the outer pot and the inner pot and is inserted into the bottom of the outer pot; a top cover is placed on the said outer pot and the said inner pot and provided with a water inlet; the water level indicator protrudes into the said cavity through the said water inlet; the periphery of the bottom of the outer pot is provided with a lot of holes are placed around the bottom of the said outer pot, with a vent hole on its upper part; a circular baffle is placed inside the said outer pot.

The self-watering flowerpot has the advantages that the self-watering flowerpot can continuously supply water to the soil by automatic watering, convenient and time-saving, the device solves the problem of often watering.

### BRIEF DESCRIPTION OF THE DRAWINGS

FIG. 1 is a structural drawing of the self-watering flowerpot

FIG. 2 is a structural drawing of a practical example of the self-watering flowerpot

FIG. 3 is a structural drawing of a practical example of the water absorbing rod

FIG. 4 is a profile figure of another practical example of the water absorbing rod

FIG. 5 is a practical example of another practical example of the self-watering flowerpot

FIG. 6 is a practical example of another practical example of the self-watering flowerpot

### DETAILED DESCRIPTION OF THE INVENTION

This invention is detailed by a practical example.

### Example 1

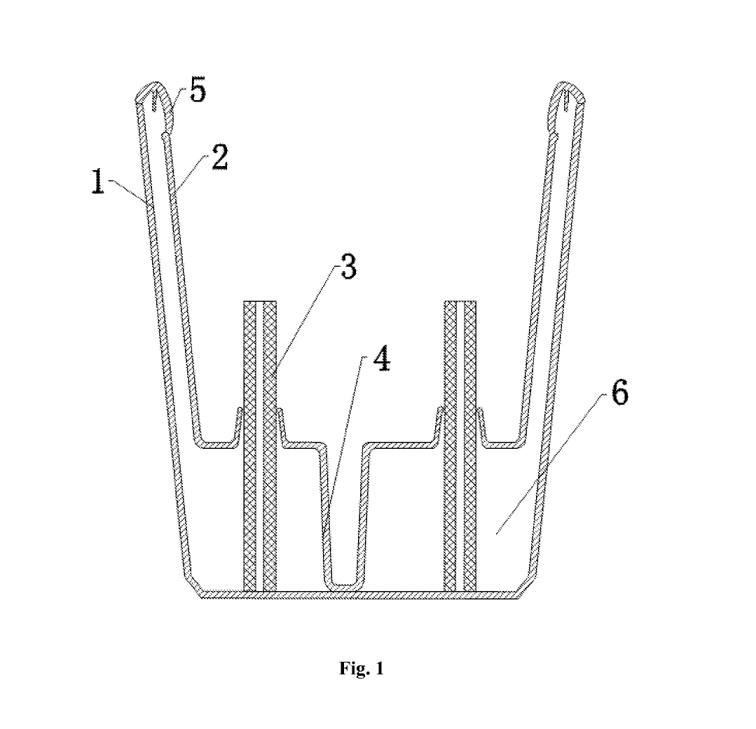

In this practical example, as shown in the FIG. 1, the structural drawing, the self-watering flowerpot comprises an outer pot 1 and an inner pot 2, the outer pot 1 is made of transparent plastics so as to observe the water level in the water tank 6, and water can be conveniently added to the water tank 6 in time when the water level is low; a support pillar 4 is mounted on the inner pot 2 and supports the inner pot which is flush with the outer pot, and since the support pillar is of a certain height, the water tank 6 can be formed between the outer pot 1 and the inner pot 2 and stores water required for the plants; the water absorbing rod 3 made of nylon plastic is used for connecting the outer pot 1 and the inner pot 2, one end of the water absorbing rod is inserted into the bottom of the outer pot 1 and directly contacts with the water in the flowerpot, and the other end protrudes into the soil in the inner pot 2 to supply water to the soil; a top cover 5 is mounted on the outer pot 1 and the inner pot 2 and can be directly taken off so as to water to be added into the water tank 6. As the nylon plastic water absorbing rod has a water absorbing function, the portion protruding into the inner pot 2 can keep the soil wet, and when the soil in the inner pot 2 is dry, water of the nylon plastic water absorbing rod can slowly permeate to the soil and keep the same wet, so that the demanded water for the plants can be provided. Further, as water permeation of the nylon plastic water absorbing rod is a slow process, watering is not needed for a long time, and the purpose of automatic watering is thereby achieved.

### Example 2

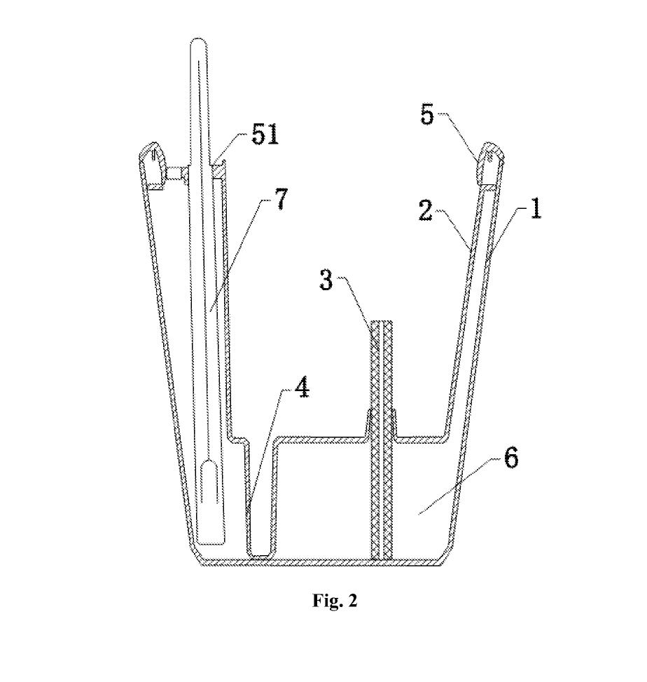

As shown in the FIG. 2, the structural drawing of another practical example of the self-watering flowerpot, a water level indicator 7 incapable of reading water level is added, and a top cover 5 that functions in decoration is mounted on both the outer pot 1 and the inner pot 2, so that the flowerpot looks more attractive. The top cover 5 is provided with a water inlet 51, one of which function is for adding water when the water storage tank 6 is of insufficient water volume and the other important function is to insert the water level indicator 7 into the bottom of the outer pot 1, so that the water level indicator 7 can directly contact with the water in the cavity and users can read water level at any time. Here, the outer pot 1 is made of ceramic or patterned plastics so as to increase sense of beauty of the flowerpot. The water inlet 51 of the top cover 5 is in an open design, so that adding water can be more convenient and simpler.

### Example 3

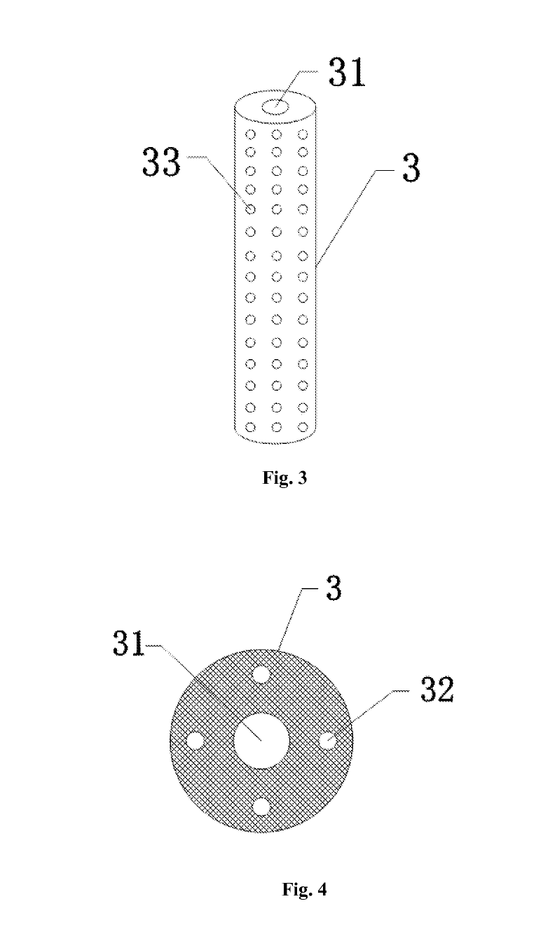

As shown in the FIG. 3, a structure of the water absorbing rod 3, the middle portion of the water absorbing rod 3 in this structure is hollowed, its water absorbing capacity can be increased; the water absorbing rod 3 at its peripheral part is provided with small water absorbing holes 33 which can be directly interconnected with the middle hollowed portion 31, and the water absorbing speed is greatly increased due to the small water absorbing holes 33 placed. By the aid of the water absorbing rod 3, water absorbing speed as well as water absorbing capacity can be increased, and the water absorbing rod 3 in the this structure is applicable to small-size plants.

### Example 4

As shown in the FIG. 4, another structure of the water absorbing rod 3, the middle portion of the water absorbing rod 3 is hollowed as well. Different from the above practical example, the water absorbing rod 3 is characterized by that the middle hollowed portion 31 at its peripheral part is provided with a lot of water absorbing holes 32 running through the water absorbing rod 3, and the water absorbing holes 32 are symmetrically distributed in the water absorbing rod 3 relative to the middle hollowed portion 31. The water absorbing rod 3 in this structure is higher in water absorbing capacity but lower in water absorbing speed as compared with those of the water absorbing rod 3 in the above practical example, however, the water absorbing rod 3 in this structure is applicable to large-size plants. While the water absorbing rods 3 in the above two structures can be mounted in the flowerpot according to practical needs.

### Example 5

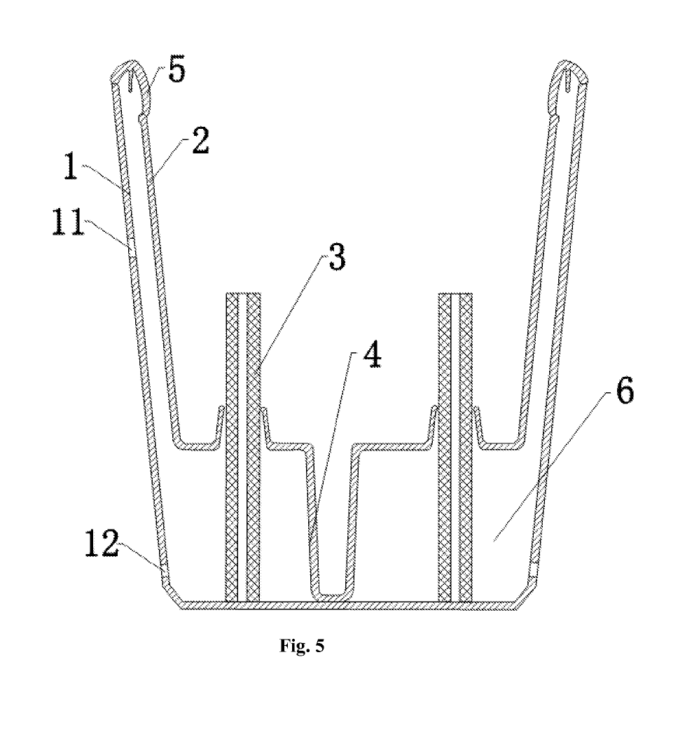

As shown in the FIG. 5, on the basis of the FIG. 1, another simpler practical example is provided that no water level indicator 7 and the water inlet 51 are placed in the flowerpot, the bottom of the outer pot 1 is provided with a lot of holes 12 through which water can enter into the water storage tank 6; the upper portion of the outer pot 1 is provided with a vent hole 11 through which pressure in the water tank 6 can be kept identical with atmospheric pressure. In this practical example, the flowerpot is placed in a basin or pool with water; the flowerpot is placed in the basin, water in the basin can enter into the water storage tank 6 via the holes 12 at the bottom of the flowerpot; by the aid of the vent hole 11, water in the basin can easily enter the water storage tank 6 until the water level in the water storage tank 6 is as high as that in the basin, thus, whether to add water or not can be judged by directly observing the water level of the basin and determining the water level of the water storage tank 6, and water only needs to be added to the basin. Without the water level indicator 7, the outer pot 1 can be made of transparent plastic or ceramics.

### Example 6

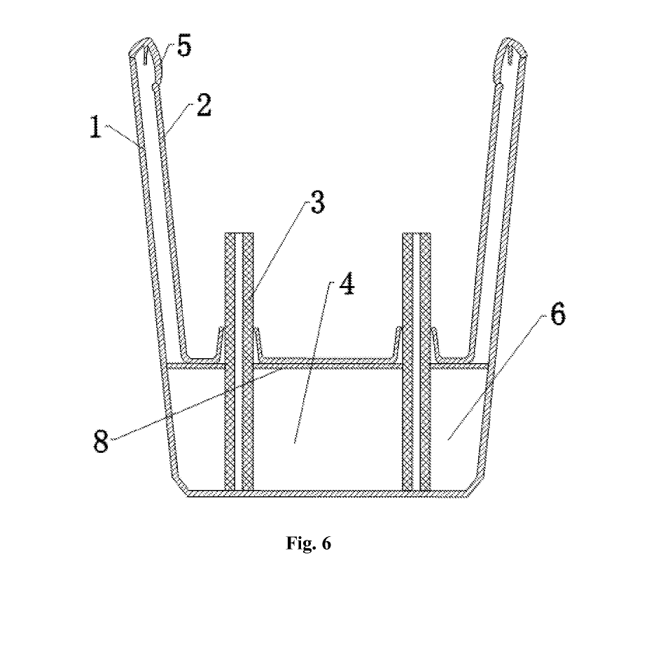

As shown in the FIG. 6, in this practical example, a circular baffle 8 is disposed inside the outer pot 1 by spacing a certain height from the bottom surface of the outer pot 1, the inner pot 2 is disposed on the baffle 8, and in this way, a water tank 6 is formed between the outer pot 1 and the inner pot 2. The circular baffle 8 is provided with a small circular hole allowing the water absorbing rod 3 to penetrate to connect the outer pot 1 with the inner pot 2, the outer pot 1 is made of transparent plastics, the bottom of the outer pot 1 is provided with small holes 12, the upper portion of the outer pot is provided with a vent hole 11, and the flowerpot is placed in a basin filled with water.

The above practical examples are preferred modes of execution of the self-watering flowerpot, which does not assume as limitations of the patent claims. Any equivalent structures or process transformations made according to the description of the attached figures or directly or indirectly applied to relevant technical field are similarly included within the scope of the patent claims of the self-watering flowerpot.

1. A self-watering flowerpot comprising
an outer pot, an inner pot and a water absorbing rod connecting the outer pot with the inner pot. One end of the said water absorption rod is inserted into the bottom of the said outer pot, and the other end protrudes into the soil of the said inner pot. A support pillar integrated with the inner pot is placed on the bottom surface of the said inner pot and supports the inner pot that is flush with the outer pot, and a water tank is shaped between the said inner pot and the said outer pot.

2. The self-watering flowerpot according to claim 1, wherein the said water absorbing rod is made of nylon plastic.

3. The self-watering flowerpot according to claim 1, wherein the said water absorbing rod is hollowed in the middle.

4. The self-watering flowerpot according to claim 1, wherein the water absorbing rod at its peripheral part is provided with small water absorbing holes that are interconnected with the middle hollowed portion.

5. The self-watering flowerpot according to claim 1, wherein a lot of water absorbing holes running through the water absorbing rod are arranged around the part symmetric relative to the said middle hollowed portion on the said water absorbing rod.

6. The self-watering flowerpot according to claim 1, wherein a water level indicator is installed in a cavity enclosed by the said outer pot and the said inner pot and inserted into the bottom of the said outer pot.

7. The self-watering flowerpot according to claim 1, wherein a top cover is placed on both the said outer pot and the said inner pot and provided with a water inlet.

8. The self-watering flowerpot according to claim 6, wherein the said water level indicator protrudes into the said cavity through the said water inlet.

9. The self-watering flowerpot according to claim 1, wherein a lot of holes are arranged around the bottom of the said outer pot and a vent hole on its upper part.

10. The self-watering flowerpot according to claim 1, wherein a circular baffle is placed inside the said outer pot.
